(19) United States
(12) Patent Application Publication
(10) Pub. No.: US 2015/0178290 A1
(43) Pub. Date: Jun. 25, 2015

(54) DISPLAY CONTROL APPARATUS, DISPLAY CONTROL METHOD, AND COMPUTER-READABLE STORAGE MEDIUM

(71) Applicant: CANON KABUSHIKI KAISHA, Tokyo (JP)

(72) Inventor: Shigeki Hirooka, Kawasaki-shi (JP)

(21) Appl. No.: 14/560,705

(22) Filed: Dec. 4, 2014

(30) Foreign Application Priority Data
Dec. 25, 2013 (JP) 2013-268082

(51) Int. Cl. G06F 17/30; G06F 3/0484; G06F 3/0485

(52) U.S. Cl. CPC G06F 17/30064; G06F 3/0485; G06F 3/04842; G06F 17/30905

(57) ABSTRACT

A display control apparatus includes: a display control unit adapted to align a plurality of data in an order of generation and display a list of the aligned data in a predetermined display area of a display unit. an acquisition unit adapted to acquire a generation time of new data when the new data is added. and a presentation unit adapted to indicate a direction in which the new data exists if the generation time of the new data falls outside a range of generation times of the data displayed as a list in the display area, thereby presenting to a user the existence of undisplayed data outside the range of the display area.

### BACKGROUND OF THE INVENTION

1. Field of the Invention

The present invention relates to a display control apparatus, display control method, and computer-readable storage medium and, more particularly, to a display control technique of displaying a plurality of data.

2. Description of the Related Art

Recently, as the Internet and cloud services spread, network communications using these computer networks are becoming popular. An example of these network communications is an SNS (Social Networking Service) such as Twitter®. Generally, data (for example, messages and images) posted from users in these network communications are time-line-displayed in time series (Japanese Patent Laid-Open Nos. 2013-8332 and 2012-53618).

In applications for performing these network communications, posted data are generally displayed as they are aligned in the order of arrival at the server. Therefore, in the past direction in time series from presently displayed posted data, only posted data already read or skipped basically exist. That is, since posted data are aligned in the order of arrival at the server, no new posted data is added in the past direction from presently displayed data.

New data is sometimes added in the past direction from presently display data, however, if posted data are time-line-displayed as they are aligned in time series in the order of, for example, creation time of the data, instead of the order of arrival at the server. For example, assume that captured images uploaded by a plurality of users are time-line-displayed as they are aligned in the order of capturing times. In this case, depending on the timing at which a given user uploads a captured image, the posted image is sometimes added in the past direction in time series from captured images already uploaded by other users and aligned. If a captured image is added in the past direction in time series from a presently displayed captured image, a user browsing the time-line display may overlook the added captured image without noticing it.

### SUMMARY OF THE INVENTION

The present invention provides a technique which improves the convenience for a reader when displaying a list of data arranged in a predetermined order.

According to one aspect of the present invention, a display control apparatus includes: a display control unit adapted to align a plurality of data in an order of generation and display a list of the aligned data in a predetermined display area of a display unit; an acquisition unit adapted to acquire a generation time of new data when the new data is added; and a presentation unit adapted to indicate a direction in which the new data exists if the generation time of the new data falls outside a range of generation times of the data displayed as a list in the display area, thereby presenting to a user the existence of undisplayed data outside the range of the display area.

According to another aspect of the present invention, a display control apparatus includes: a first display control unit adapted to cause a display area of a display unit to display at least some of a plurality of data as display targets arranged in a predetermined order based on time information associated with each of the plurality of data; and a second display control unit adapted to cause the display unit to display, if received data is not displayed in the display area when the received data is added to the arrangement of the plurality of data in accordance with the predetermined order, information indicating that display target data is newly added and indicating a scroll direction for displaying the received data.

According to still another aspect of the present invention, a display control method to be executed by each unit of a display control apparatus, includes: a display control step of causing a display control unit to align a plurality of data in an order of generation and display a list of the aligned data in a predetermined display area of a display unit; an acquisition step of causing an acquisition unit to acquire a generation time of new data when the new data is added; and a presentation step of causing a presentation unit to indicate a direction in which the new data exists if the generation time of the new data falls outside a range of generation times of the data displayed as a list in the display area, thereby presenting to a user the existence of undisplayed data outside the range of the display area.

Further features of the present invention will become apparent from the following description of exemplary embodiments (with reference to the attached drawings).

### BRIEF DESCRIPTION OF THE DRAWINGS

FIG. 1 is a system configuration view of a posted data display system.

FIG. 2 is a block diagram showing an example of the hardware configuration of an information processing apparatus.

FIG. 3 is a block diagram showing an example of the functional configuration of a display control apparatus.

FIG. 4 is a conceptual view showing an example of the data structure of a posted data information list.

FIG. 5 is a conceptual view showing an example of the data structure of posted data information.

FIG. 6 is a conceptual view showing an example of the display screen of the display control apparatus.

FIG. 7 is a flowchart showing an example of a process when a posting addition notification is received.

FIG. 8 is a flowchart showing an example of an addition notification process according to an embodiment of the present invention.

FIG. 9 is a flowchart showing an example of a display updating process according to the embodiment of the present invention.

FIG. 10 is a conceptual view representing the positional relationship between the display screen and posted data.

FIG. 11 is a conceptual view representing a screen display after a display range has moved.

FIG. 12 is a flowchart showing an example of a display range moving process according to the embodiment of the present invention.

FIG. 13 is a conceptual view representing the positional relationship between the display screen and posted data.

FIG. 14 is a flowchart showing an example of an addition notification process according to an embodiment of the present invention.

FIG. 15 is a flowchart showing the first example of a comparison process according to the embodiment of the present invention.

FIG. 16 is a flowchart showing the second example of the comparison process according to the embodiment of the present invention.

FIG. 17 is a flowchart showing the third example of the comparison process according to the embodiment of the present invention.

FIG. 18 is a flowchart showing the fourth example of the comparison process according to the embodiment of the present invention.

### DESCRIPTION OF THE EMBODIMENTS

An embodiment of the present invention will be explained in detail below with reference to the accompanying drawings.

In this embodiment, a posted data display system which displays images uploaded by a plurality of users by aligning the images in time series will be explained. In the following explanation, uploaded data will be called posted data. Also, the explanation will be made by assuming that posted data is an image, but posted data may also be character data such as a message.

(Posted Data Display System)

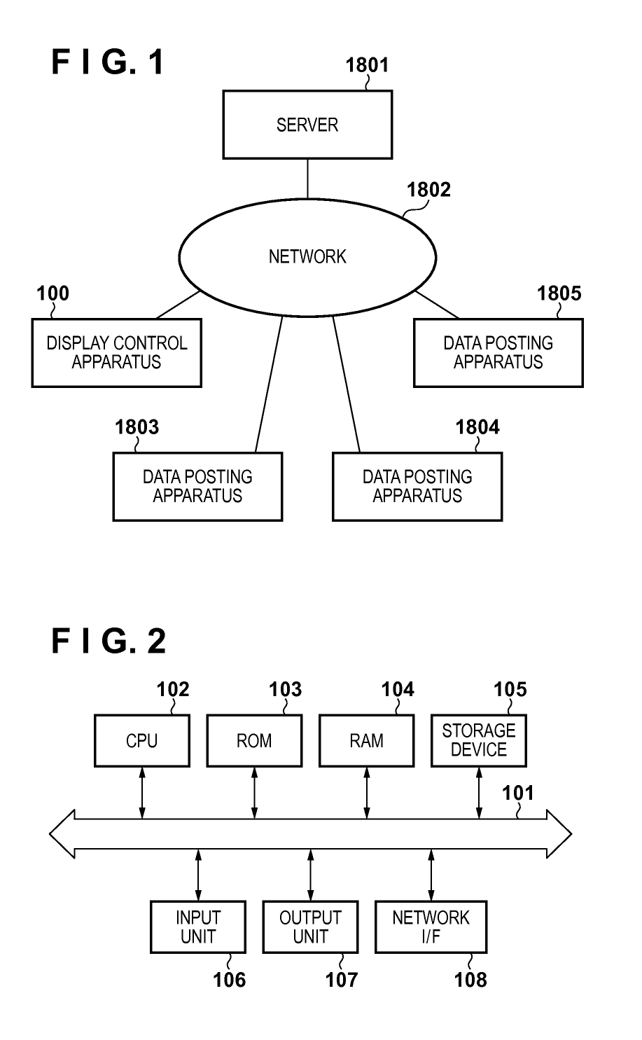

FIG. 1 is a system configuration view of the posted data display system according to this embodiment. The posted data display system includes a display control apparatus 100, a server 1801, and data posting apparatuses 1803 to 1805. The server 1801 is an information processing apparatus for performing a process of causing the display control apparatus 100 to display data posted from each data posting apparatus. A network 1802 is a computer network such as the Internet for allowing these apparatuses to communicate with each other. The data posting apparatuses 1803 to 1805 are apparatuses for posting grouped posted data to the server 1801 across the network 1802. The display control apparatus 100 displays data posted by the data posting apparatuses 1803 to 1805. Note that the users of the data posting apparatuses 1803 to 1805 and display control apparatus 100 are grouped, and the server 1801 allows the grouped users to browse each other's posted data.

(Hardware Configuration)

Each of the display control apparatus 100, server 1801, data posting apparatuses 1803 to 1805 according to this embodiment can be implemented by an information processing apparatus such as a tablet terminal, smartphone, personal computer (PC), or WS. FIG. 2 is a block diagram showing an example of the hardware configuration of this information processing apparatus.

The information processing apparatus includes a CPU (Central Processing Unit) 102. The CPU 102 is a constituent element which performs arithmetic operations and logical determination for various processes (to be described later), and exchanges data and instructions. The CPU 102 controls constituent elements connected to a system bus 101. This information processing apparatus incorporates memories including a program memory and data memory. The program memory stores a computer program for causing the CPU 102 to perform control in order to execute a procedure in accordance with each flowchart (to be described later). The program memory may be a ROM (Read Only Memory) 103, or a RAM (Random Access Memory) 104 to which a program is loaded from a storage device 105 or the like. The storage device 105 is implemented by, for example, a flash memory or hard disk for storing data and programs according to this embodiment. The storage device 105 also stores information about posted data. An input unit 106 is implemented by, for example, a touch sensor, pointing device, or keyboard for allowing a user to input information or perform operations. An output unit 107 outputs processing results from the information processing apparatus to the user. The output unit 107 is implemented by a display including an output circuit such as a graphic controller, but may also include a loudspeaker or the like.

Note that in the display control apparatus 100 according to this embodiment, posted data is displayed and various operations are performed by using a touch panel obtained by combining the input unit 106 and output unit 107. A network I/F 108 performs a process of connecting to the network 1802. The network I/F 108 is implemented by, for example, a modem for connecting to an external network. The network I/F 108 may also be a chip or antenna for performing communication in a wireless LAN (Local Area Network), public wireless telephone channel, or Bluetooth®.

(Functional Configuration of Display Control Apparatus)

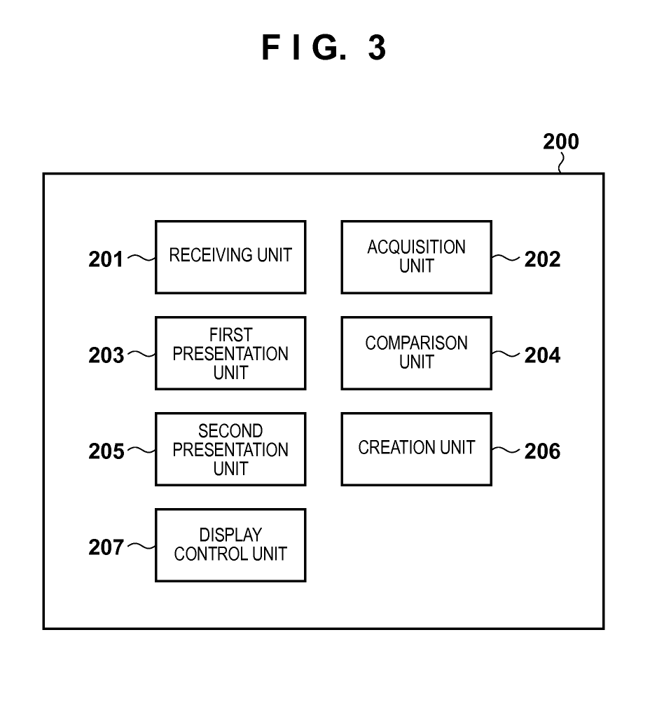

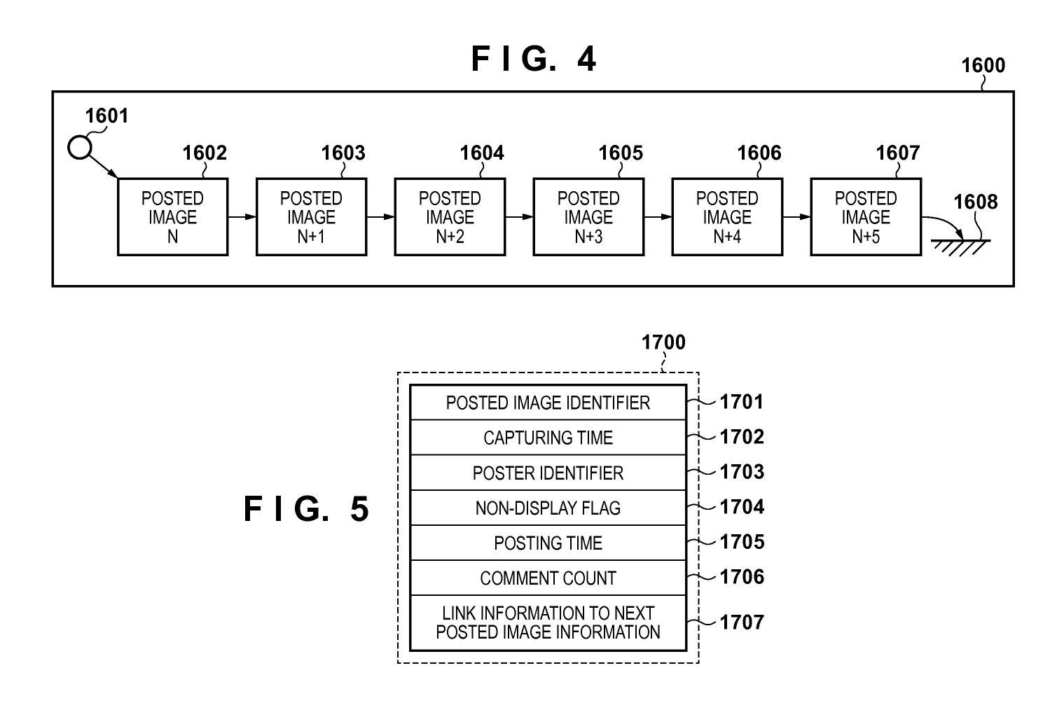

FIG. 3 is a block diagram showing an example of the functional configuration of the display control apparatus 100 according to this embodiment. FIG. 3 shows a whole display control apparatus 200. A receiving unit 201 receives a posted data addition notification from the server 1801. An acquisition unit 202 acquires a posted data creation time. When posted data is image data, the acquisition unit 202 can acquire the creation time of the image data from Exif information of the image data, or refer to the creation date/time or update date/time of a posted data file. The acquisition unit 202 may also acquire information managed by a database or file separately from the posted data. When additional posted data is added to a list in which all posted data are aligned in time series in accordance with capturing times, if the posted data is placed outside the range of a display area, a first presentation unit 203 presents to the user that the posted data is added outside the range of the display area. A comparison unit 204 compares posted data placed outside the range of the display area in the past direction and future direction of the range of the display area in time series, and determines which of undisplayed posted data in the past direction and future direction has a higher importance. Details of this comparison will be described later. A second presentation unit 205 presents to the user the time-series direction having a higher importance outside the range of the display area, which is determined by the comparison unit 204 by comparing the posted data. A creation unit 206 creates a posted data information list shown in FIG. 4 and posted data information shown in FIG. 5 based on information from the server 1801. A display control unit 207 controls the display of image data to be output to the output unit 107.

(Operation of Posted Data Display System)

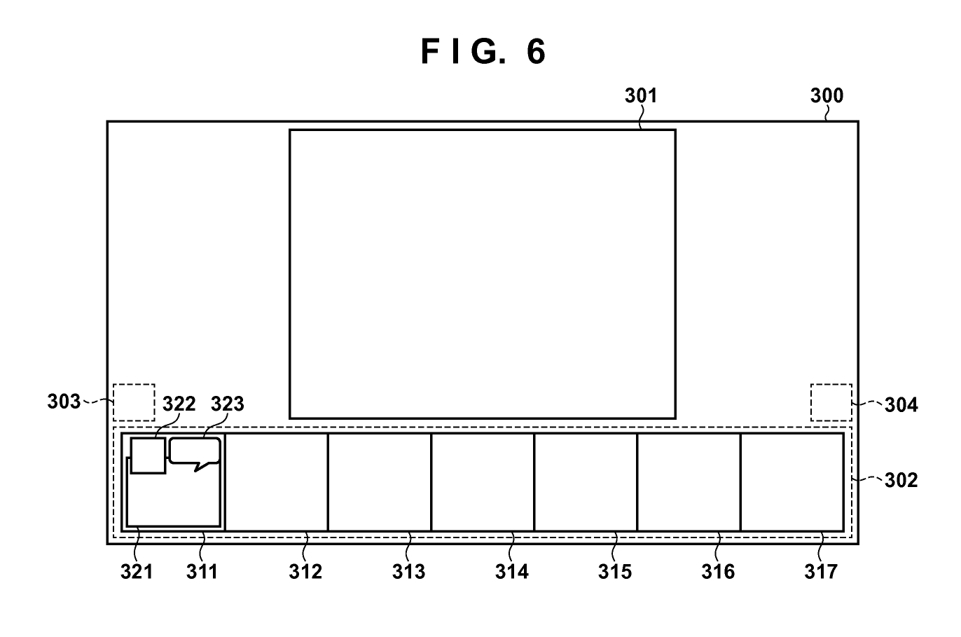

The operation of the posted data display system having the above arrangement will be explained with reference to FIG. 6. FIG. 6 is a view showing an example of the display screen of the display control apparatus 100, which is used to display posted data.

This display screen example shown in FIG. 6 is displayed on a display as the output unit 107. FIG. 6 shows a display area 300. The display area 300 displays at least some of a plurality of data as display targets arranged in a predetermined order based on time information associated with the plurality of data. An enlarged display area 301 displays a selected one of the posted data in an enlarged scale. A list display area 302 displays a list of posted data. The list display area 302 includes posted data display areas 311 to 317. Note that the list display area 302 includes the seven posted data display areas in this embodiment, but the number of areas is not limited to seven and may also be larger or smaller than that. At least some posted data in the posted data list in which all posted data are arranged in the order of capturing time are placed in the posted data display areas 311 to 317. Note that in the posted data display areas 311 to 317, data are arranged in descending order of capturing time from the right to the left in FIG. 6. That is, posted data having the latest capturing time is placed in the posted data display area 317, and posted data are arranged in descending order to capturing time from the posted data display area 317 to the posted data display area 311. Note that the arrangement of posted data arranged in the posted data display areas 311 to 317 is changed by a scrolling operation performed via the input unit 106 of the display control apparatus 100. For example, posted data to be displayed in each posted data display area is scrolled in accordance with dragging, swiping, or flicking on the touch panel. Thus, posted data to be displayed as a list are switched in accordance with scroll instructions from the user.

Each posted data display area includes a thumbnail image display area 321, poster display area 322, and symbol display area 323. The thumbnail image display area 321 displays a thumbnail of posted data. The poster display area 322 displays an image associated with the poster of posted data placed in the corresponding posted data display area. In this embodiment, the poster display area 322 displays a face image of the poster (the user of one of the data posting apparatuses 1803 to 1805) of posted data. When the present time falls within a predetermined period since posted data placed in the corresponding posted data display area is newly added, the symbol display area 323 displays information indicating that the posted data is newly added posted data. The symbol display area 323 also displays information indicating that posted data placed in the corresponding posted data display area is displayed in the display area 300 for the first time.

When posted data having a capturing time earlier than those of posted data displayed in the list display area 302 is newly added, a first addition notification area 303 displays information indicating that display target data is newly added. This information displayed in the first addition notification area 303 indicates that the added posted data is displayed by performing scrolling such that posted data having early capturing times are displayed. The information displayed in the first addition notification area 303 also indicates that in the array of posted data, there is undisplayed posted data having a capturing time earlier than that of posted data placed in the posted data display area 311. Note that the information displayed in the first addition notification area is so controlled as not to be displayed when the added posted data is displayed in the list display area 302 based on the scrolling operation of the user.

When posted data having a capturing time later than those of posted data displayed in the list display area 302 is newly added, a second addition notification area 304 displays information indicating that display target data is newly added. This information displayed in the second addition notification area 304 indicates that the added posted data is displayed by performing scrolling such that posted data having late capturing times are displayed. The information displayed in the second addition notification area 304 also indicates that there is undisplayed posted data having a capturing time later than that of posted data placed in the posted data display area 317. Note that the information displayed in the second addition notification area is so controlled as not to be displayed when the added posted data is displayed in the list display area 302 based on the scrolling operation of the user.

(Posted Data Information List)

A plurality of data to be displayed are arranged in a predetermined order based on time information associated with each data. FIG. 4 is a view showing an example of the data structure of a posted data information list for displaying a list of posted data in the order based on the time information. FIG. 4 shows a whole posted data information list 1600. The posted data information list 1600 is stored in the RAM 104 or storage device 105. Link information 1601 always indicates a link to information of posted data having the latest capturing time. Each of posted data information 1602 to 1607 stores information about one posted data. As shown in FIG. 4, this posted data information list has a linear list structure. Like a one-dimensional arrangement, the “linear list” herein mentioned is used to process a data string, and obtained by connecting, by using pointers, elements called nodes containing data and the pointers. Each posted data information contains link information to next posted data information. Assume that pieces of posted data information are arranged in descending order of capturing time from the one having the latest capturing time. An end terminal 1608 indicates posted data information having the earliest capturing time in the posted data information list.

(Posted Data Information)

FIG. 5 is a view showing an example of the data structure of each of the posted data information 1602 to 1607 shown in FIG. 4. Reference numeral 1700 denotes the whole of one posted data information. An identifier 1701 indicates posted data saved in the server 1801. By designating this identifier, the display control apparatus 100 acquires, from the server 1801, a thumbnail image to be displayed in the thumbnail image display area 321, or a real image to be displayed in the enlarged display area 301. A capturing time 1702 indicates the capturing time of posted data. An identifier 1703 indicates a poster who has posted data. A flag 1704 indicates that no posted data is displayed in the list display area 302. A posting time 1705 indicates the posting time of posted data. A comment count 1706 indicates the number of comments for posted data. Link information 1707 indicates a link to next posted data information in the posted data information list. A link to the end terminal 1608 is held in the link information 1707 of posted data information having the earliest capturing time in the posted data information list.

(Procedure in Display Control Apparatus)

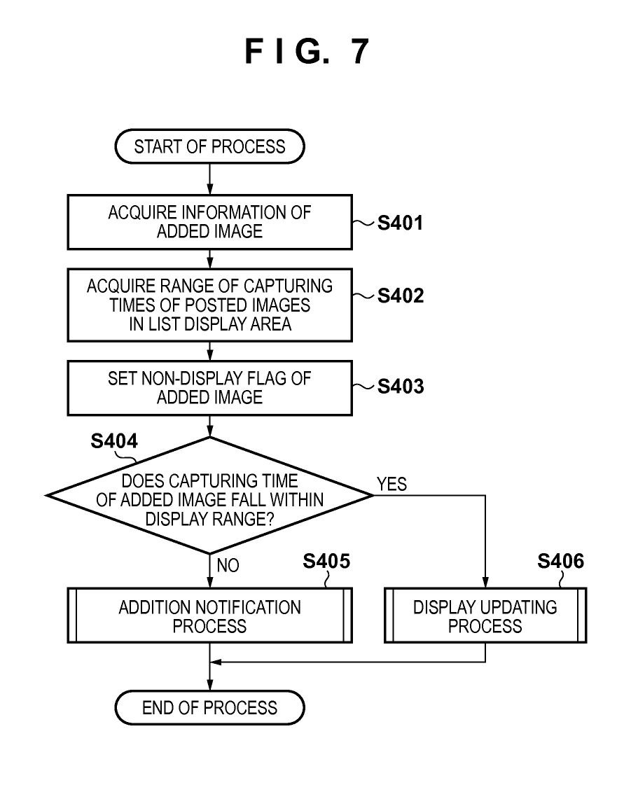

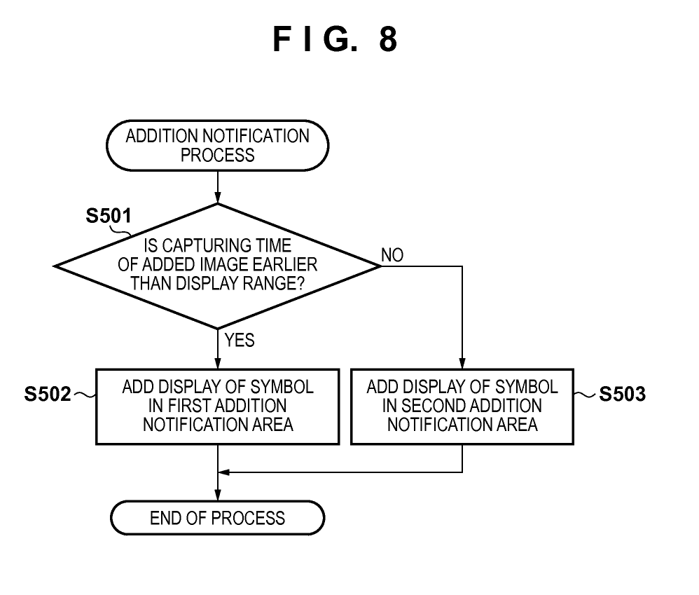

FIG. 7 is a flowchart showing an example of a process performed in the display control apparatus 100 when data is newly posted. Each step shown in FIG. 7 is executed under the control of the CPU 102 of the display control apparatus 100.

First, as a precondition of the process in the display control apparatus 100, one of the data posting apparatuses 1803 to 1805 posts new data to the server 1801 across the network 1802. When the data is newly posted, the server 1801 transmits, to the display control apparatus 100, a posting addition notification indicating that new posted data is added to the group to which the display control apparatus 100 belongs.

The receiving unit 201 of the display control apparatus 100 receives the posting addition notification from the server 1801. In addition, the receiving unit 201 acquires, from the server, information of the added posted data notified by the posting addition information (step S401). Then, the creation unit 206 adds the information about the acquired added posted data to the posted data information 1700. Furthermore, the creation unit 206 adds the information about the added posted data to the posted data information list 1600.

Subsequently, the CPU 102 acquires the capturing time of posted data presently placed in the posted data display area 311 and the capturing time of posted data placed in the posted data display area 317, and acquires the range of the capturing times of posted data presently displayed in the list display area 302 (step S402). Although not shown, this display control apparatus stores, in the RAM 104 or storage device 105, link information indicating the posted data information of posted data placed in the posted data display area 317, thereby acquiring the capturing time of the posted data placed in the posted data display area 317. Note that it is also possible to acquire the capturing time of posted data placed in the posted data display area 317 by tracing the posted data information list 1600. Alternatively, the generation time of posted data may also be acquired based on the transmission time of the posted data, the time at which the posted data is added to a queue for managing posted data to be displayed, or the update time of the posted data, instead of the creation time (capturing time) of the posted data.

Then, the CPU 102 sets the non-display flag 1704 for the posted data information added in step S401 (step S403). The CPU 102 determines whether the capturing time of the added posted data obtained in step S401 falls within the range of the capturing times of presently displayed posted data obtained in step S402 (step S404). If it is determined in step S404 that the capturing time of the added posted data falls outside the capturing time range (NO in step S404), the CPU 102 executes a process (to be referred to as an “addition notification process” hereinafter) which notifies the addition of posted data falling outside the display range (step S405). If the capturing time of the added posted data falls within the capturing time range (YES in step S404), the CPU 102 executes a process (to be referred to as a “display updating process” hereinafter) which updates the display in the list display area 302 (step S406), and terminates the procedure. Details of the addition notification process in step S405 and the display updating process in step S406 will be explained below.

(Addition Notification Process)

In the addition notification process, if received data is not displayed in the display area when the data is added to the data arrangement in accordance with a predetermined order, the CPU 102 executes a process of adding the display of a symbol in the first or second addition notification area 303 or 304. As described previously, each of the addition notification areas 303 and 304 functions as information indicating that new display target data is added, and indicating a scroll direction for displaying the received data.

FIG. 8 is a flowchart showing an example of the procedure of the addition notification process executed in step S405. FIG. 8 shows steps S501 to S503.

First, the CPU 102 determines whether the capturing time of the added posted data is in the past direction from the capturing time range of posted data presently displayed in the list display area 302 (step S501). That is, the CPU 102 determines whether the capturing time of the added posted data is before the earliest one of the capturing times of the presently displayed posted data. If it is determined in step S501 that the capturing time is in the past direction (YES in step S501), the CPU 102 adds, to the first addition notification area 303, the display of a symbol indicating that there is added posted data in the past direction from the display range (step S502), and terminates the process. On the other hand, if it is determined in step S501 that the capturing time is not in the past direction (NO in step S501), the CPU 102 adds, to the second addition notification area 304, the display of a symbol indicating that there is added posted data in the future direction from the display range (step S503), and terminates the process.

(Display Updating Process)

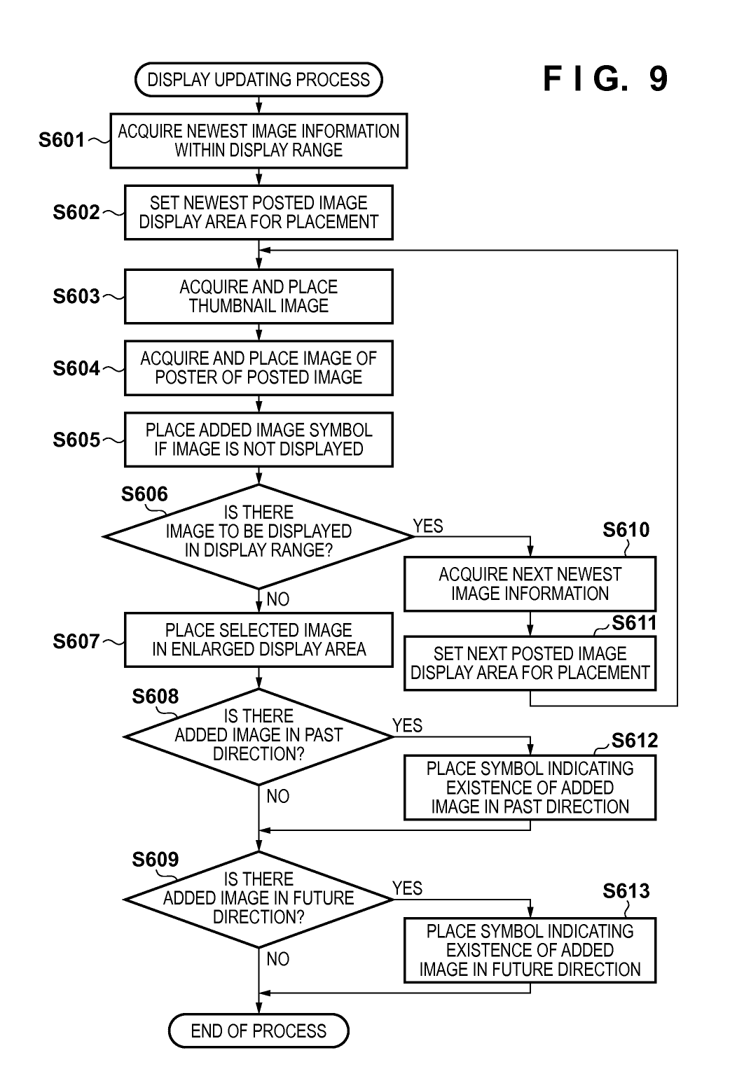

FIG. 9 is a flowchart showing an example of the display updating process executed in step S406. FIG. 9 shows steps S601 to S613.

First, the CPU 102 acquires posted data information having the latest capturing time from among posted data arranged in the list display area 302 (step S601). More specifically, the CPU 102 acquires this posted data information by referring to link information indicating posted data information of posted data stored in the RAM 104 or storage device 105 and placed in the posted data display area 317. Then, the CPU 102 sets a posted data display area for displaying the newest posted data in the list display area 302, that is, the posted data display area 317 as a posted data display area for a placement target (step S602).

Subsequently, the CPU 102 acquires a thumbnail of posted data from the server by using the posted data identifier 1701 of the posted data information acquired in step S601 and places the thumbnail in the thumbnail image display area 321 of the posted data display area 317 of the placement target (step S603). The CPU 102 then acquires an image of the poster of the posted image from the server by using the poster identifier 1703 of the acquired posted data information, and places the image of the poster in the poster display area 322 of the posted data display area (step S604). If the non-display flag 1704 of the obtained posted data information is set, the CPU 102 displays a symbol indicating added posted data in the symbol display area 323 of the posted data display area for a placement target (step S605).

After that, the CPU 102 determines whether there is posted data to be placed in the list display area 302 (step S606). More specifically, the CPU 102 performs this determination by, for example, determining whether the link information 1707 to next posted data information of the posted data information acquired in step S601 indicates an end terminal. If it is determined in step S606 that posted data to be displayed still exists (YES in step S06), the CPU 102 acquires the next newest posted data information in the posted data information list 1600 (step S610). The CPU 102 then sets the next posted data display area in the list display area 302 as a posted data display area for a placement target (step S611), and returns to the process in step S602. By the processes in steps S603 to S606, S611, and S610 as described above, the CPU 102 displays all posted data in the list display area 302 by arranging the data in order from the posted data display area having the latest time.

If it is determined in step S606 that there is no posted data to be displayed in the display range (NO in step S606), the CPU 102 places selected posted data (if there is no selected data, the newest image is set as selected posted data) in the enlarged display area 301 (step S607). Then, the CPU 102 searches the posted data information list 1600, and determines whether there is undisplayed posted data in the past direction from the capturing time range of posted data presently displayed in the list display area 302 (step S608). If it is determined in step S608 that undisplayed posted data exists in the past direction (YES in step S608), the process advances to step S612. if not (NO in step S608), the process advances to step S609. In step S612, the CPU 102 displays a symbol indicating that there is undisplayed posted data in the past direction in the first addition notification area 303, and advances to step S609.

In step S609, the CPU 102 searches the posted data information list 1600, and determines whether there is undisplayed posted data in the future direction from the capturing time range of the posted data presently displayed in the list display area 302. If it is determined in step S609 that undisplayed posted data exists (YES in step S609), the CPU 102 displays a symbol indicating that there is added posted data in the future direction in the second notification display area 304 (step S613), and terminates the process. If it is determined in step S609 that there is no added posted data in the future direction (NO in step S609), the CPU 102 immediately terminates the process.

(Outline of Display Range Movement)

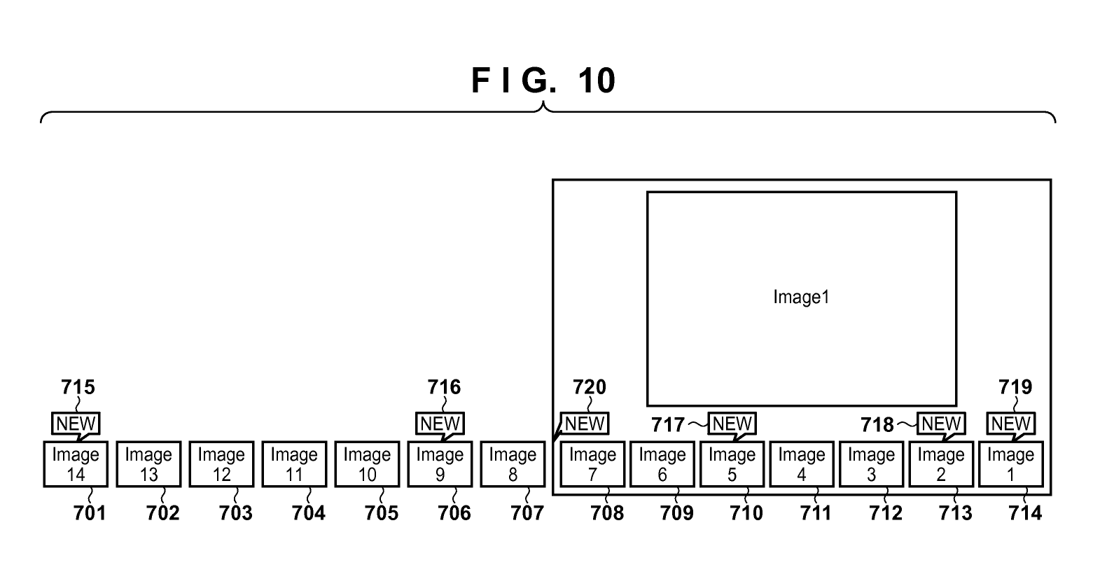

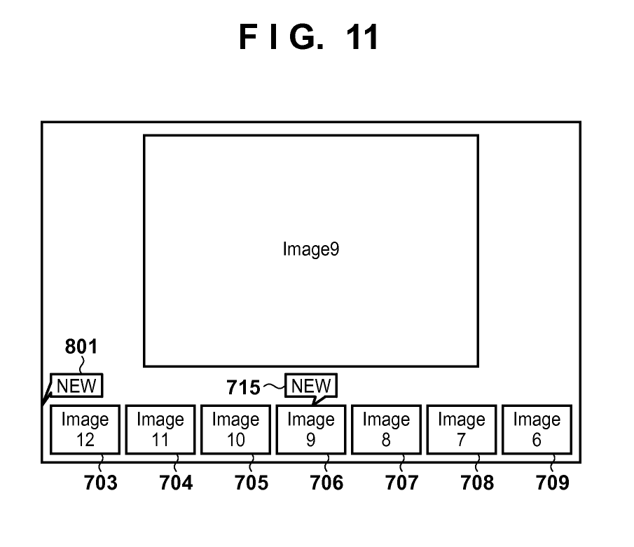

In this embodiment, posted data to be displayed as a list are switched in accordance with a scroll designation by the selection of the symbol 303 or 304, such that undisplayed posted data is positioned in the center of the display area. This process will be explained with reference to FIGS. 10 and 11. FIG. 10 is a conceptual view showing the positional relationship between the display screen and posted data according to this embodiment. FIG. 10 shows posted data 701 to 714. The posted data 708 to 714 are arranged in the list display area 302. Symbols 715, 716, 717, 718, and 719 above the posted data 701, 706, 710, 713, and 714 respectively indicate that the posted data 701, 706, 710, 713, and 714 are images soon after they are posted or images not displayed after they are posted. That is, the posted data 701 and 706 are posted data added outside the display range but not displayed, and the posted data 710, 713, and 714 are posted data soon after they are added. A symbol 720 is placed and displayed in the first addition notification area 303, and indicates that there is undisplayed posted data in the past direction from the capturing time range of posted data presently displayed in the list display area 302. When the user presses this symbol on the screen, the display range is set such that undisplayed posted data existing outside the display range and closest in the past direction, that is, the posted data 706 is displayed in the center.

FIG. 11 is a conceptual view showing a screen display after the user has pressed the symbol indicating that there is undisplayed added posted data in the past direction from the display range shown in FIG. 10. As shown in FIG. 11, the posted data are arranged in the list display area 302 so that the undisplayed posted data 706 existing outside the display range and closest in the past direction in FIG. 10 is displayed in the center. In addition, the posted data 706 is displayed in an enlarged scale in the enlarged display area 301. A symbol 801 indicates that there is undisplayed posed data in the past direction from the capturing time range of posted data presently displayed in the list display area 302. That is, the symbol 801 represents that the undisplayed posted data 701 exists in the capturing time past direction of the list display area 302 shown in FIG. 10.

(Display Range Moving Process)

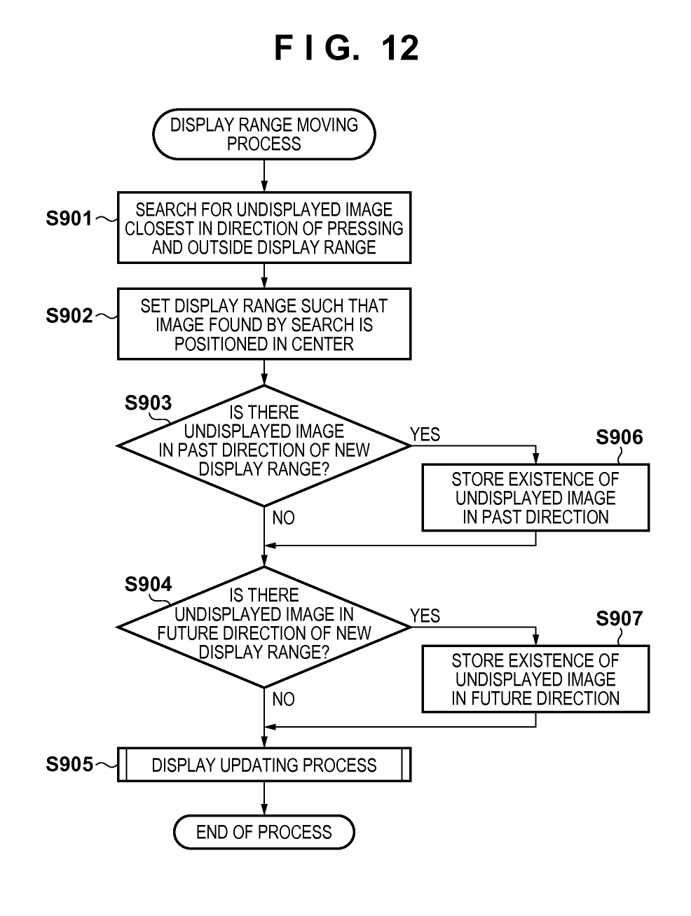

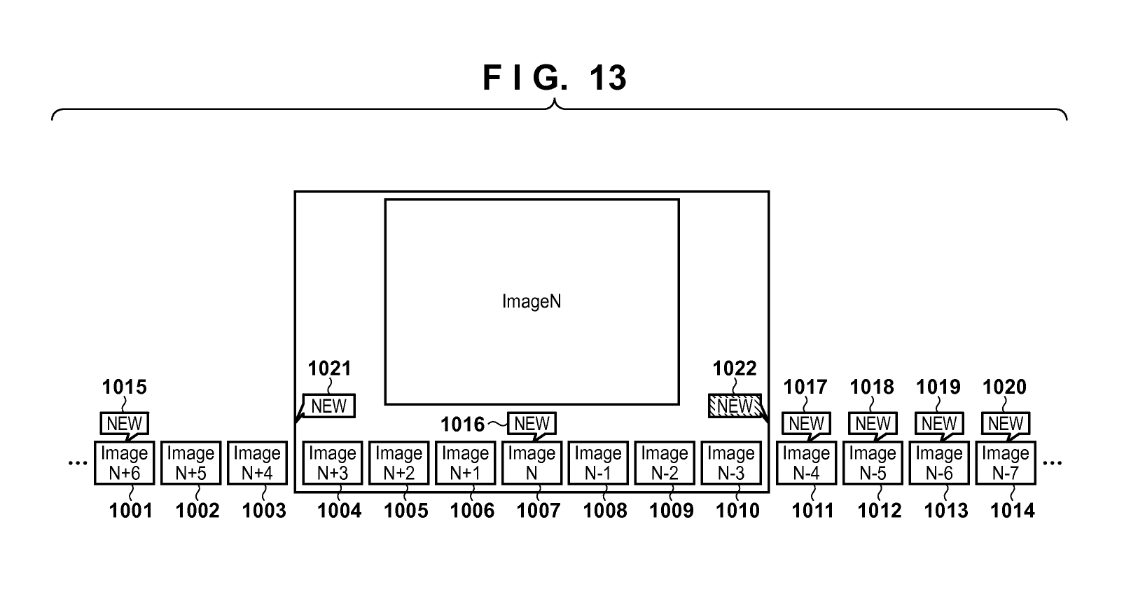

FIG. 12 is a flowchart showing an example of the procedure of a display range moving process to be executed when the symbol indicating the existence of undisplayed added posted data outside the display range is pressed. FIG. 12 shows steps S901 to S907. Each step shown in FIG. 12 is executed under the control of the CPU 102 of the display control apparatus 100.

First, the CPU 102 searches the posted data information list 1600 for undisplayed posted data closest to the display range from among undisplayed posted data outside the display range in the list display area 302 in the direction of pressing (step S901). Then, the CPU 102 updates link information stored in the RAM 104 or storage device 105 and indicating posted data information of posted data placed in the posted data display area 317 such that the posted data found by the search is displayed in the center, thereby setting a posted data range to be newly displayed in the list display area 302 (step S902). Subsequently, the CPU 102 searches the posted data information list 1600, and determines whether there is undisplayed posted data in the past direction from the new display range (step S903). If undisplayed posted data exists in the past direction (YES in step S903), the CPU 102 stores information indicating the existence of the undisplayed posted data (step S906). In addition, the CPU 102 searches the posted data information list 1600, and determines whether there is undisplayed posted data in the future direction from the posted data range displayed in the new list display area 302 (step S904). If undisplayed posted data exists in the future direction (YES in step S904), the CPU 102 stores information indicating the existence of the undisplayed posted data (step S907). After that, the CPU 102 executes a display updating process in step S905, and terminates the process. Practical contents of the display updating process are the same as explained with reference to FIG. 9.

As described above, the display control apparatus 100 according to this embodiment displays a list of a plurality of posted data in a predetermined display area of the display device by aligning the data in the order of generation, and, when new posted data is added, acquires the generation time of the new posted data. If the generation time of the new posted data falls outside the range of the generation times of the posted data displayed as a list in the display area, the display control apparatus 100 indicates a direction in which the new posted data exists, thereby presenting to the user the existence of undisplayed posted data outside the range of the display area. In this embodiment, therefore, even if the addition position of added posted data in the posted data list falls outside the range displayed in the display area, the user can recognize the addition of the posted data. In addition, the user can readily recognize whether the posted data is added in the past direction or future direction in time series outside the range displayed in the display area of the posted data list.

Note that posted data are aligned based on the capturing times of the posted data in this embodiment, but the basis of the alignment is not limited to the capturing time of posted data. It is also possible to use the transmission time of posted data, the time at which posted data is placed in a transmission queue (the time at which a transmission reservation is made), or the update time of a posted data file, provided that posted data are aligned based on times different from the times of arrival at the server. This makes it possible to align posted data based on not the capturing time of each posted data but the time at which the poster of each posted data has transmitted the data or has made a transmission reservation. This is effective in communication using an already captured image, because in this case the time at which the poster has posted the image is more important than the capturing time of the image. Also, when making a product by processing an image, the creation time of the final product is more important than the capturing time of the original image. Aligning posted data based on the update time of the posted data file is effective in a case like this.

Furthermore, this embodiment has been explained by taking a case in which targets to be displayed as a list are posted data as an example, but the display target is not limited to posted data. For example, the present invention is also applicable to a case in which images captured by digital cameras or received e-mails are displayed as a list. In addition, when undisplayed data exists in this embodiment, the user is notified of the existence by indicating the direction in which the data exists by the symbol 303 or 304. However, the method of indicating the direction in which undisplayed data exists is not limited to this. For example, the notification may also be performed by using a sound or the vibration of a controller.

In this embodiment as described above, in the display control apparatus 100 for displaying a plurality of data on a display device, a virtual queue is generated by aligning the plurality of data in a predetermined order, and the display device displays a list of data corresponding to a predetermined number of consecutive nodes in the queue. If undisplayed data exists, the user is notified of a direction in which the data exists. This allows the user to recognize the direction in which the data exists, and accurately view the undisplayed data by a scroll operation or the like. Note that the same function can also be implemented by forming a virtual list of the plurality of data aligned in the predetermined order, displaying a part of the virtual list on the display device, and indicating a direction in which undisplayed data exists.

In this embodiment, an example in which, when posted data are added in both the past direction and future direction in time series outside the range displayed in the posted data list display area, the direction in which the posted data which the user should view first exists is presented to the user will be explained. Many of the arrangements and operations of the posted data display system and display control apparatus 100 according to this embodiment are the same as those of the above-described embodiment, so differences from the above-described embodiment will mainly be explained.

(Display of Posted Data)

In this embodiment, undisplayed posted data generated before the range of the generation times of posted data displayed as a list is compared with undisplayed posted data generated after the generation time range, and a direction in which the undisplayed posted data exists and which has a higher importance is determined. Then, the direction having a higher importance is presented to the user. This makes it possible to preferentially view data having a higher importance when a large amount of data are posted.

FIG. 13 is a conceptual view showing the relationship between the display screen and posted data according to this embodiment. FIG. 13 shows posted data 1001 to 1014. The posted data 1004 to 1010 are displayed in the list display area 302. Symbols 1015, 1016, 1017, 1018, 1019, and 1020 above the posted data 1001, 1007, 1011, 1012, 1013, and 1014 respectively indicate that the posted data 1001, 1007, 1011, 1012, 1013, and 1014 are images soon after they are posted or images not displayed after they are posted. That is, the posted data 1001 and 1011 to 1014 are posted data added outside the display range but not displayed, and the posted data 1007 is posted data soon after it is added. A symbol 1021 is placed and displayed in the first addition notification area 303, and indicates that there is undisplayed posted data in the past direction from the capturing time range of posted data presently displayed in the list display area 302. A symbol 1022 is placed and displayed in the second addition notification area 304, and indicates that there is undisplayed posted data in the future direction from the capturing time range of posted data presently displayed in the list display area 302. In this example shown in FIG. 13, the number of posted data added outside the display range but not displayed is one in the past direction from the capturing time range of the posted data presently displayed in the list display area 302, and four in the future direction, that is, the number is larger in the future direction. Therefore, the symbol 1022 indicating the existence of the undisplayed posted data in the future direction is emphasized in dark color.

(Addition Notification Process)

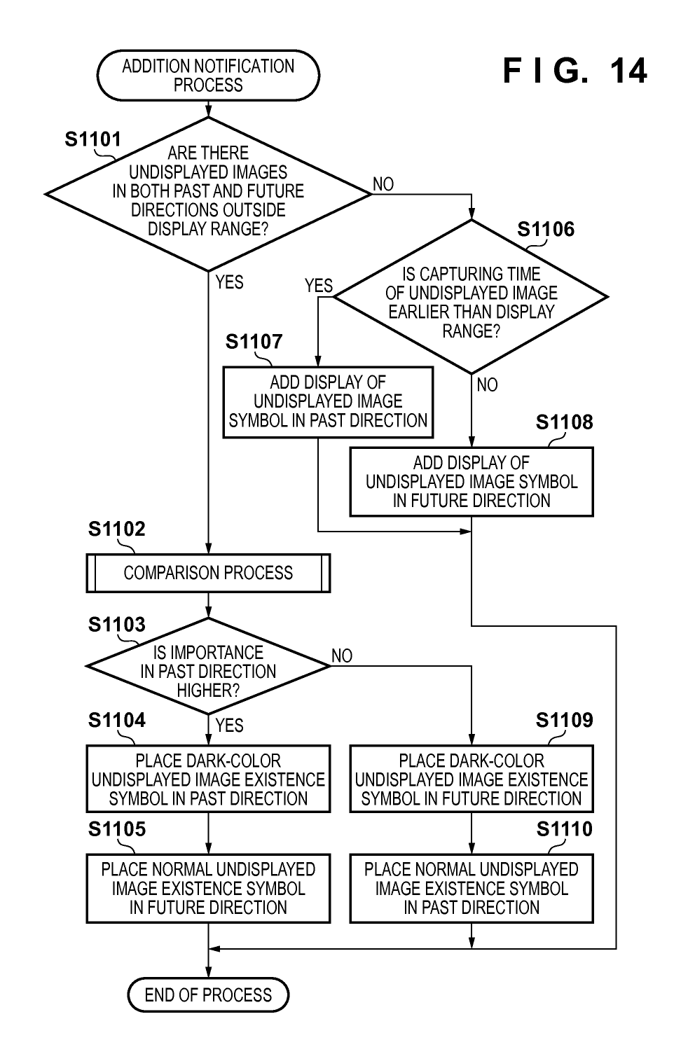

FIG. 14 is a flowchart showing an example of a process (addition notification process) of notifying the addition of posted data outside the display range according to this embodiment. FIG. 14 shows steps S1101 to S1110. Each step shown in FIG. 14 is executed under the control of the CPU 102 of the display control apparatus 100.

First, the CPU 102 obtains posted data information of posted data placed in the posted data display area 317 from link information stored in the RAM 104 or storage device 105, and traces image information equal in number to posted data which can be displayed in the list display area 302. Thus, the CPU 102 obtains the range of the capturing times of posted data presently displayed in the list display area 302, and determines whether undisplayed posted data exist in both the past and future directions outside the range by searching the posted data information list 1600 (step S1101). If it is determined in step S1101 that undisplayed posted data exist in both the past and future directions (YES in step S1101), the process advances to step S1102. In step S1102, the CPU 102 executes a process (to be referred to as a “comparison process” hereinafter) of comparing the importances of the undisplayed posted data in the past and future directions. Details of this comparison process will be described later.

Then, the CPU 102 determines whether the importance of the undisplayed posted data in the past direction is higher than that of the undisplayed posted data in the future direction (step S1103). If it is determined in step S1103 that the importance of the undisplayed posted data in the past direction outside the capturing time range of the posted data presently displayed in the list display area 302 is higher (YES in step S1103), the process advances to step S1104. In step S1104, the CPU 102 places an emphasized symbol indicating the existence of the undisplayed posted data having a high importance in the first addition notification area 303. In this embodiment, a dark-color undisplayed image indication symbol is placed and displayed as this symbol. Subsequently, the CPU 102 places and displays a normal-color undisplayed image indication symbol in the future-direction undisplayed posted data notification display area 304 (step S1105), and terminates the process. If it is determined in step S1103 that the importance of the undisplayed posted data in the past direction outside the capturing time range of the posted data presently displayed in the list display area 302 is not higher (NO in step S1103), the process advances to step S1109. In step S1109, the CPU 102 places and displays the dark-color undisplayed image indication symbol in the future-direction undisplayed posted data notification display area 304. The CPU 102 then places and displays a normal-color undisplayed image indication symbol in the first addition notification area 303 (step S1110), and terminates the process.

If it is determined in step S1101 that undisplayed posted data exists in one of the past and future directions (NO in step S1101), the process advances to step S1106. In step S1106, the CPU 102 determines whether the capturing time of the added image is earlier than the capturing time range of the posted data presently displayed in the list display area 302 (step S1106). If it is determined in step S1106 that the capturing time of the added image is earlier than the capturing time range of the presently displayed posted data (YES in step S1106), the CPU 102 places a normal-color undisplayed image indication symbol in the first addition notification area 303 (step S1107), and terminates the process. If it is determined in step S1106 that the capturing time of the added image is later than the capturing time range of the presently displayed posted data (NO in step S1106), the CPU 102 places a normal-color undisplayed image indication symbol in the future-direction undisplayed posted data notification display area 304 (step S1108), and terminates the process.

(Comparison Process)

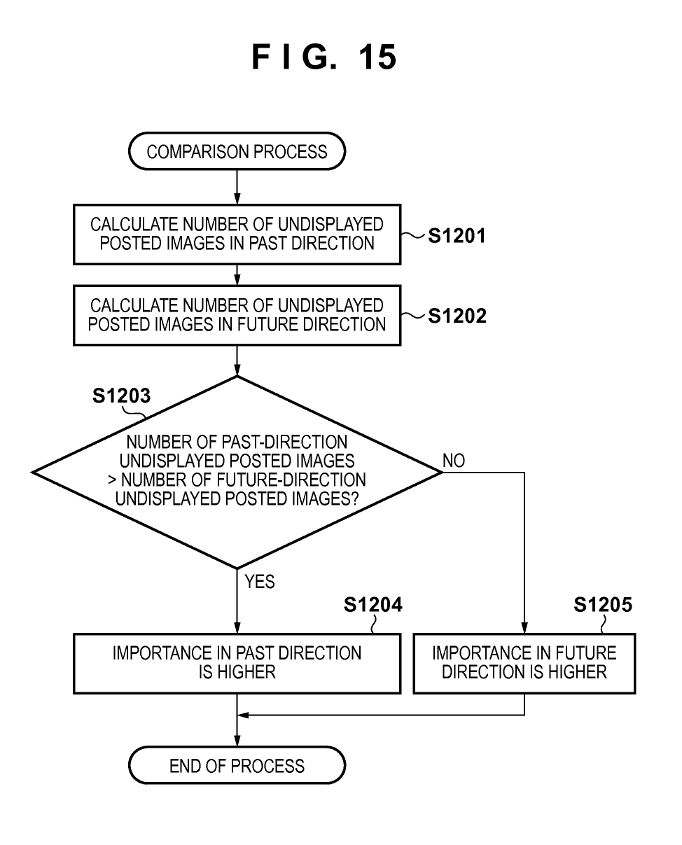

Next, details of the comparison process will be explained with reference to FIGS. 15 to 18. FIG. 15 is a flowchart showing the first example of the comparison process of comparing undisplayed posted data in the past and future directions according to this embodiment. FIG. 15 shows steps S1201 to S1205.

In the first example of the comparison process, the CPU 102 compares the number of undisplayed posted data generated before the range of the generation times of posted data displayed as a list with the number of undisplayed posted data generated after the generation time range, thereby determining a direction in which the importance is high. First, the CPU 102 calculates the total number of undisplayed posted data in the past direction in time series outside the range of the capturing times of posted data presently displayed in the list display area 302 (step S1201). The calculation method is to count the number of posted data information for which the non-display flag 1704 is set in the posted data information list 1600. Then, the CPU 102 similarly calculates the total number of undisplayed posted data in the future direction in time series outside the range of the capturing times of posted data presently displayed in the list display area 302 (step S1202). Subsequently, the CPU 102 determines whether the number of past-direction undisplayed posted data obtained in step S1201 is larger than that of future-direction undisplayed posted data obtained in step S1202 (step S1203). If it is determined in step S1203 that the number of past-direction undisplayed posted data is larger (YES in step S1203), the CPU 102 determines that the importance is higher in the past direction (step S1204), and terminates the process. If the number of future-direction undisplayed posted data is larger (NO in step S1203), the CPU 102 determines that the importance is higher in the future direction (step S1205), and terminates the process.

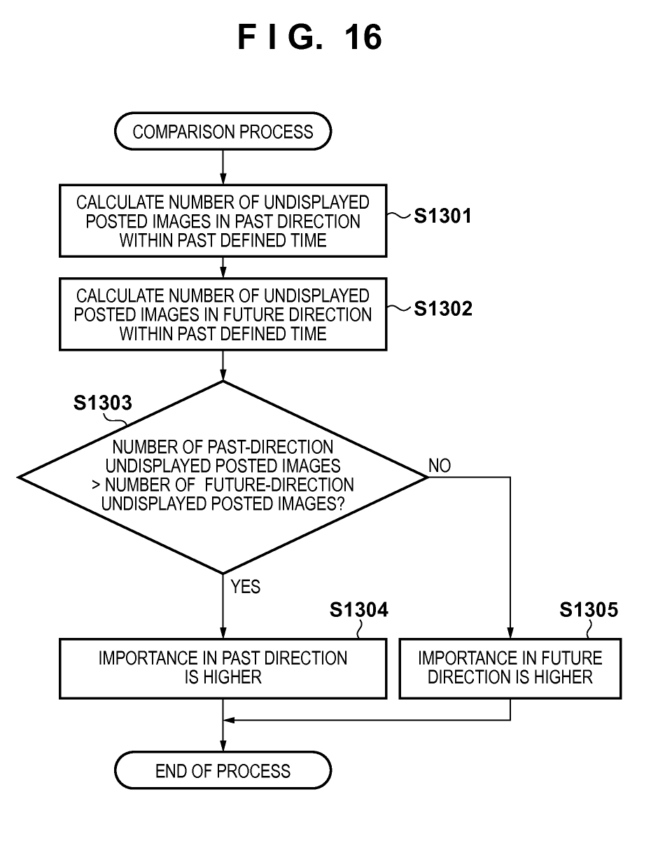

FIG. 16 is a flowchart showing the second example of the comparison process of comparing undisplayed posted data in the past and future directions according to this embodiment. FIG. 16 shows steps S1301 to S1305.

In the second example of the comparison process, the numbers of undisplayed posted data existing in a predetermined range of temporal distances from the range of generation times are compared. First, the CPU 102 calculates the total number of undisplayed posted data added within a predetermined fixed time ΔT in the past direction in time series outside the range of the capturing times of posted data presently displayed in the list display area 302 (step S1301). The calculation method is to count the number of posted data information for which the posting time 1705 falls within closest ΔT and the non-display flag 1704 is set in the posted data information list 1600. Then, the CPU 102 calculates the total number of undisplayed posted data added within the predetermined fixed time ΔT in the future direction in time series outside the range of the capturing times of posted data presently displayed in the list display area 302 (step S1302). Subsequently, the CPU 102 determines whether the number of past-direction undisplayed posted data obtained in step S1301 is larger than that of future-direction undisplayed posted data obtained in step S1302 (step S1303). If it is determined in step S1303 that the number of past-direction undisplayed posted data is larger (YES in step S1303), the CPU 102 determines that the importance is higher in the past direction (step S1304), and terminates the process. If the number of future-direction undisplayed posted data is larger (NO in step S1303), the CPU 102 determines that the importance is higher in the future direction (step S1305), and terminates the process.

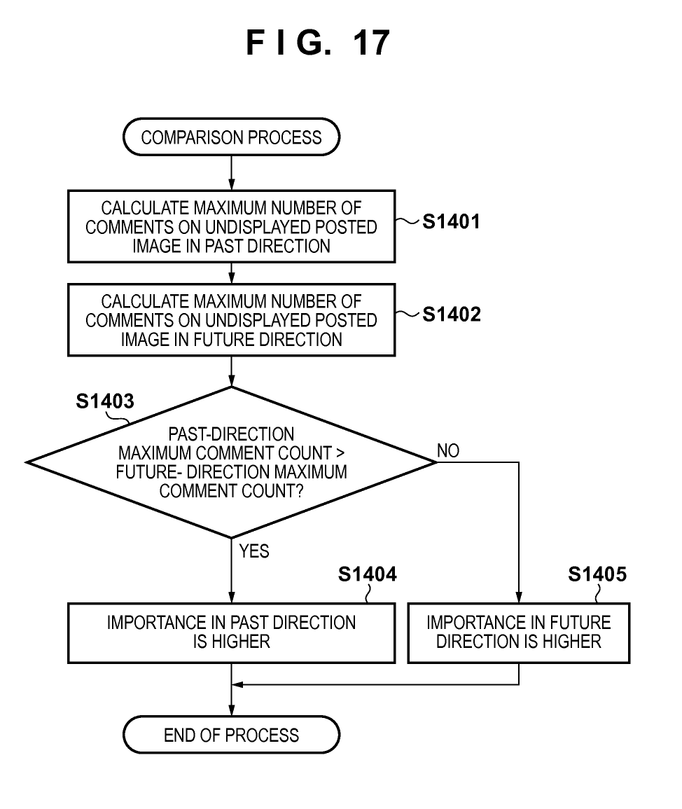

FIG. 17 is a flowchart showing the third example of the comparison process of comparing undisplayed posted data in the past and future directions according to this embodiment. FIG. 17 shows steps S1401 to S1405.

In the third example of the comparison process, the number of comments on undisplayed posted data generated before posted data displayed as a list is compared with the number of comments on undisplayed posted data created after the posted data displayed as a list. First, the CPU 102 acquires the number of comments on an undisplayed image having a maximum comment count from undisplayed posted data in the past direction in time series outside the range of the capturing times of posted data presently displayed in the list display area 302 (step S1401). The number of comments of an undisplayed image having a maximum comment count is acquired by comparing the comment counts 1706 of posted data information for which the non-display flag 1704 is set in the posted data information list 1600, and searching for the largest comment count. Then, the CPU 102 acquires the number of comments on an undisplayed image having a maximum comment count from undisplayed posted data in the future direction in time series outside the range of the capturing times of the posted data presently displayed in the list display area 302 (step S1402). Subsequently, the CPU 102 determines whether the maximum comment count in the past direction obtained in step S1401 is larger than that in the future direction obtained in step S1402 (step S1403). If it is determined in step S1403 that the maximum comment count in the past direction is larger (YES in step S1403), the CPU 102 determines that the importance is higher in the past direction (step S1404), and terminates the process. If the maximum comment count in the future direction is larger (NO in step S1403), the CPU 102 determines that the importance is higher in the future direction (step S1405), and terminates the process.

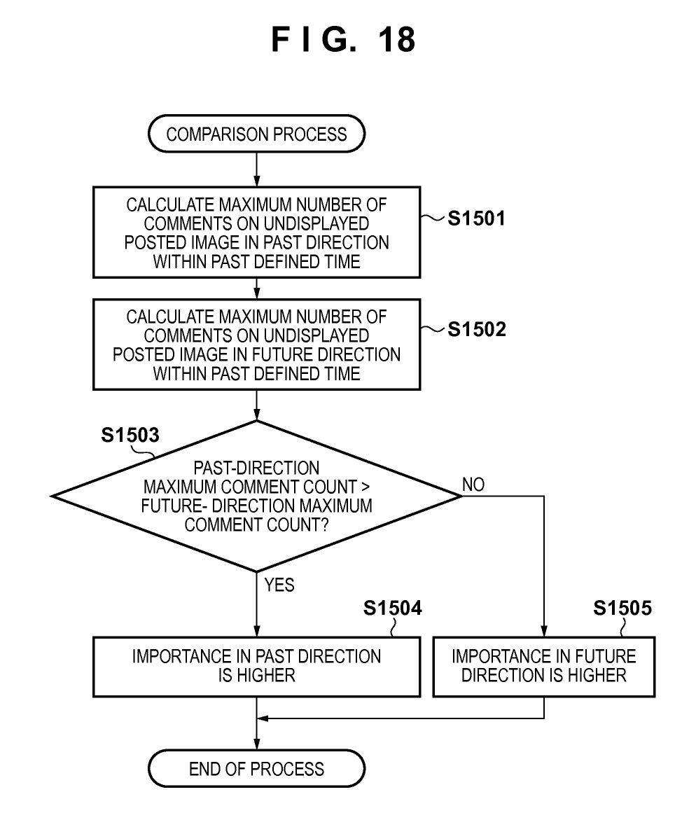

FIG. 18 is a flowchart showing the fourth example of the comparison process of comparing undisplayed posted data in the past and future directions according to this embodiment. FIG. 18 shows steps S1501 to S1505.

In the fourth example of the comparison process, undisplayed posted data given a maximum number of comments is acquired from undisplayed posted data existing in a predetermined range of temporal distances from the range of generation times, and a direction in which this undisplayed posted data exists is determined as a direction in which the importance is high. First, the CPU 102 acquires the number of comments of an undisplayed image having a maximum comment count from undisplayed posted data added within a predetermined fixed time ΔT in the past direction in time series outside the range of the capturing times of posted data presently displayed in the list display area 302 (step S1501). The number of comments of an undisplayed image having a maximum comment count is acquired by comparing the comment counts 1706 of posted data information for which the posting time 1705 falls within closest ΔT and the non-display flag 1704 is set in the posted data information list 1600, and searching for the largest comment count. Then, the CPU 102 acquires the number of comments of an undisplayed image having a maximum comment count from undisplayed posted data added within the predetermined fixed time ΔT in the future direction in time series outside the range of the capturing times of the posted data presently displayed in the list display area 302 (step S1502). Subsequently, the CPU 102 determines whether the maximum comment count in the past direction obtained in step S1501 is larger than that in the future direction obtained in step S1502 (step S1503). If it is determined in step S1503 that the maximum comment count in the past direction is larger (YES in step S1503), the CPU 102 determines that the importance is higher in the past direction (step S1504), and terminates the process. If the maximum comment count in the future direction is larger (NO in step S1503), the CPU 102 determines that the importance is higher in the future direction (step S1505), and terminates the process.

In this embodiment as described above, when posted data are added in both the past and future directions in time series from the presently displayed range, a direction in which the posted data which the user should view first exists can be presented to the user.

Note that in this embodiment, the direction in which the posted data which the user should view first exists is represented by the density of color. However, the direction may also be expressed by the difference between colors, a shape, a pattern, or the difference between sizes. It is also possible to express the direction by the addition of a special symbol, character string, or image. Furthermore, in this embodiment, posted data are aligned based on the capturing times of the posted data. However, the basis of the alignment is not limited to the capturing times of posted data. It is also possible to use the transmission time of posted data, the time at which posted data is placed in a transmission queue (the time at which a transmission reservation is made), or the update time of a posted data file, provided that posted data are aligned based on times different from the times of arrival at the server. Note that the above-described display control apparatus may also be an image capturing apparatus having an image capturing function of capturing an image. In this case, the apparatus can further have a function of uploading an image captured by the image capturing function. Also, the method of determining the importance of undisplayed posted data is not limited to the above-described methods. For example, if the number of comments given to undisplayed posted data exceeds a predetermined threshold, it is possible to determine that the direction of the undisplayed posted data is a direction in which the importance is high.

The present invention can provide the technique of improving the convenience for a reader when displaying a list of data arranged in a predetermined order.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-268082, filed Dec. 25, 2013, which is hereby incorporated by reference herein in its entirety.

What is claimed is:

1. A display control apparatus comprising:
a display control unit adapted to align a plurality of data in an order of generation and display a list of the aligned data in a predetermined display area of a display unit.
an acquisition unit adapted to acquire a generation time of new data when the new data is added. and
a presentation unit adapted to indicate a direction in which the new data exists if the generation time of the new data falls outside a range of generation times of the data displayed as a list in the display area, thereby presenting to a user the existence of undisplayed data outside the range of the display area.

2. The apparatus according to claim 1, wherein said display control unit switches data to be displayed as a list in accordance with a scroll instruction from the user.

3. The apparatus according to claim 1, wherein said display control unit switches data to be displayed as a list in accordance with a scroll instruction from the user, such that the undisplayed data is positioned in a center of the display area.

4. The apparatus according to claim 1, further comprising a determination unit adapted to compare undisplayed data generated before the range of the generation times of the data displayed as a list in the display area with undisplayed data generated after the range of the generation times, and determine a direction in which the undisplayed data exists and an importance is higher,
wherein said presentation unit presents to the user the direction in which the importance is higher.

5. The apparatus according to claim 4, wherein said determination unit compares the number of undisplayed data generated before the range of the generation times with the number of undisplayed data generated after the range of the generation times, and determines a direction in which the importance is higher.

6. The apparatus according to claim 5, wherein said determination unit compares the numbers of undisplayed data existing in a predetermined range of temporal distances from the range of the generation times.

7. The apparatus according to claim 4, wherein said determination unit compares the number of comments given to undisplayed data generated before the range of the generation times with the number of comments given to undisplayed data generated after the range of the generation times, and determines a direction in which the importance is higher.

8. The apparatus according to claim 7, wherein said determination unit determines, as a direction in which the importance is higher, a direction in which undisplayed data given a largest number of comments among undisplayed data existing in a predetermined range of temporal distances from the range of the generation times exists.

9. The apparatus according to claim 1, wherein said acquisition unit acquires the generation time based on one of a data creation time, a data transmission time, a time at which data is added to a queue for managing display target data, and a time at which data is updated.

10. A display control apparatus comprising:
a first display control unit adapted to cause a display area of a display unit to display at least some of a plurality of data as display targets arranged in a predetermined order based on time information associated with each of the plurality of data. and
a second display control unit adapted to cause said display unit to display, if received data is not displayed in the display area when the received data is added to the arrangement of the plurality of data in accordance with the predetermined order, information indicating that display target data is newly added and indicating a scroll direction for displaying the received data.

11. The apparatus according to claim 10, further comprising an arrangement unit adapted to arrange the plurality of data as display targets in the predetermined order based on the time information of each of the plurality of data.

12. A display control method to be executed by each unit of a display control apparatus, comprising:
a display control step of causing a display control unit to align a plurality of data in an order of generation and display a list of the aligned data in a predetermined display area of a display unit.
an acquisition step of causing an acquisition unit to acquire a generation time of new data when the new data is added. and
a presentation step of causing a presentation unit to indicate a direction in which the new data exists if the generation time of the new data falls outside a range of generation times of the data displayed as a list in the display area, thereby presenting to a user the existence of undisplayed data outside the range of the display area.

13. A non-transitory computer-readable storage medium storing a computer program which causes a computer to function as each unit of a display control apparatus cited in claim 1.
